(19) United States
(12) Patent Application Publication
(10) Pub. No.: US 2016/0106080 A1
(43) Pub. Date: Apr. 21, 2016

(54) SPEAR FISHING SHAFT ASSEMBLY

(71) Applicant: Chris W. Chaput, San Carlos, CA (US)

(72) Inventor: Chris W. Chaput, San Carlos, CA (US)

(21) Appl. No.: 14/874,090

(22) Filed: Oct. 2, 2015

Related U.S. Application Data
(60) Provisional application No. 62/064,173, filed on Oct. 15, 2014.

(51) Int. Cl. A01K 81/04; F41B 7/04

(52) U.S. Cl. CPC A01K 81/04; F41B 7/04

(57) ABSTRACT

A shaft assembly includes a cylindrical body with at least one recessed slot. Each recessed slot has a length aligned with a main axis of the cylindrical body, a width and a depth profile. The shaft assembly also includes at least one tab, each having a base and a fin portion. The base of each tab is adapted to engage a corresponding one of the recessed slots within the length and the width of the recessed slot, and has a base profile to match the depth profile of the recessed slot.

### PRIORITY

The present application claims priority under 35 U.S.C. § 119(e) from commonly owned U.S. Provisional Application No. 62/064,173, filed on Oct. 15, 2014, to Chris W. Chaput. The entire disclosure of U.S. Provisional Application No. 62/064,173 is specifically incorporated herein by reference.

### BACKGROUND

Band-powered spear guns are ubiquitous in the popular sport of spear fishing. A band-powered spear gun includes a spear, or “shaft” that may be propelled from a stock of a spear gun via energy that is stored in one or more stretched elastic bands.

The shaft has an elongated cylindrical portion that has a pointed tip on a front end and a detent on a rear end. The pointed tip is for penetrating fish and other prey. The detent on the rear end engages a trigger mechanism that is typically integrated into the stock.

The shaft also includes one or more tabs that protrude from the rear end of the cylindrical portion of the shaft. In a profile view, each tab protrudes from the cylindrical portion of the shaft to have an appearance similar to a miniature shark fin, so that a rear edge of the tab can receive and removeably capture a portion of the elastic band when the spear gun is in a loaded state.

The portion of the elastic band received by the tab is called a “wishbone”, which typically includes a short piece of rope or cord that enables the elastic band to engage with a corresponding tab when the elastic band is in a stretched position. The number of tabs that protrude from a shaft typically corresponds to the number of elastic bands that are included in the spear gun. With the elastic bands in the stretched position, the spear gun is in the loaded state. During discharge (firing state) of the spear gun, the trigger mechanism releases the shaft and the elastic bands propel the shaft in a direction that is led by the pointed tip on the front end of the shaft.

In commercially available shafts, the tabs are typically attached to the cylindrical portion of the shaft in a configuration shown in FIGS. 1A-1C. In this configuration, the bottom surface B1 of the tab T1 contacts an outer curved surface DS1, or alternatively a flat spot (not shown) that is ground on the outer curved surface DS1, of the cylindrical portion C1 of the shaft S1. Manufacturing this type of shaft relies on the tab being carefully held in position with the bottom surface B1 of the tab in contact with the outer curved surface DS1 of the cylindrical portion, while the tab is attached by welding. In this type of shaft, the integrity of the weld W1 at the interface between the cylindrical portion C1 and the tab T1 is critical since the weld provides substantially all of the mechanical strength for the connection between the cylindrical portion and tab. Absent the weld, the tab would not be mechanically secured to the cylindrical portion of the shaft. During use, tremendous shear stress is imposed at this welded interface between the tab and cylindrical portion of the shaft, as most of the firing force provided by the elastic bands is imparted to this interface in the loaded and firing states of the spear gun, wherein the wishbone of the elastic band forcefully engages the tab. To increase the integrity of the weld at the interface, a high temperature, deep penetration welding process is typically relied upon, and large weld fillets W1 are provided along the outer contact perimeter of the interface between the cylindrical portion and the tab. The deep penetration weld typically involves high temperature processing that may warp or otherwise distort the cylindrical portion of the shaft, thereby requiring an extra manufacturing process of straightening, or truing of the shaft. The processes of positioning the tab on the outer surface of the cylindrical portion and the deep penetration welding typically increase manufacturing complexity and may increase the manufacturing cost of these types of commercially available shafts.

In view of the above, there is a need for a shaft assembly that may reduce the complexity of manufacturing processes.

### SUMMARY

A shaft assembly according to embodiments of the present invention comprises a cylindrical body that includes at least one recessed slot each having a length aligned with a main axis of the cylindrical body, and having a width and a depth profile. The shaft assembly also includes at least one tab, each having a base and a fin portion. The base is adapted to engage the recessed slot within the length and the width of the recessed slot, and has a base profile to match the depth profile of the recessed slot.

### BRIEF DESCRIPTION OF THE DRAWINGS

The present invention can be better understood with reference to the following Figures. The components in the Figures and the different views shown are not necessarily to scale. Emphasis is instead placed upon illustrating the principles and elements of the present invention.

FIGS. 1A, 1B and 1C show a perspective view, a detailed end view and a detailed side view, respectively, of a prior art shaft.

FIGS. 2A, 2B and 2C show a perspective view, a detailed end view and a detailed side view, respectively, of an example of a shaft assembly according to embodiments of the present invention.

FIGS. 3A, 3B and 3C show a perspective view, a detailed end view and a detailed side view, respectively, of an example of a cylindrical body of a shaft assembly according to embodiments of the present invention.

FIGS. 4A-4E show alternative examples of tabs suitable for inclusion in the cylindrical body of shaft assemblies according to embodiments of the present invention.

FIGS. 5A-5D show alternative examples of a shaft assembly according to alternative embodiments of the present invention.

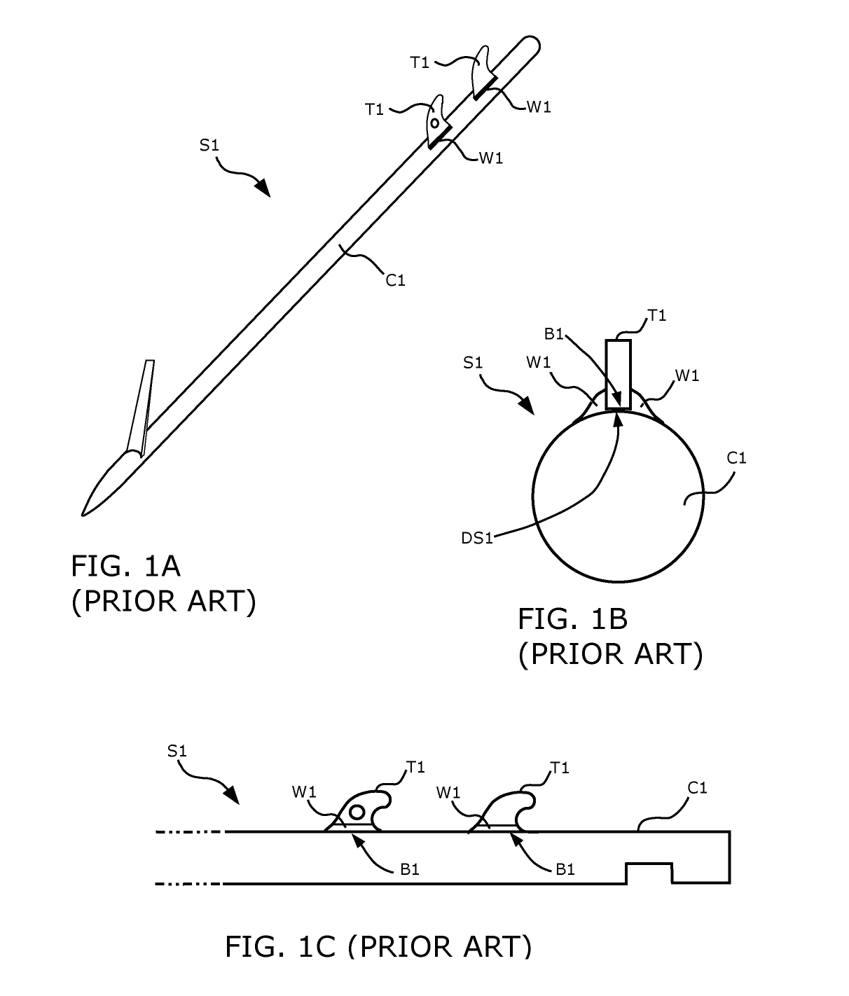

### DETAILED DESCRIPTION

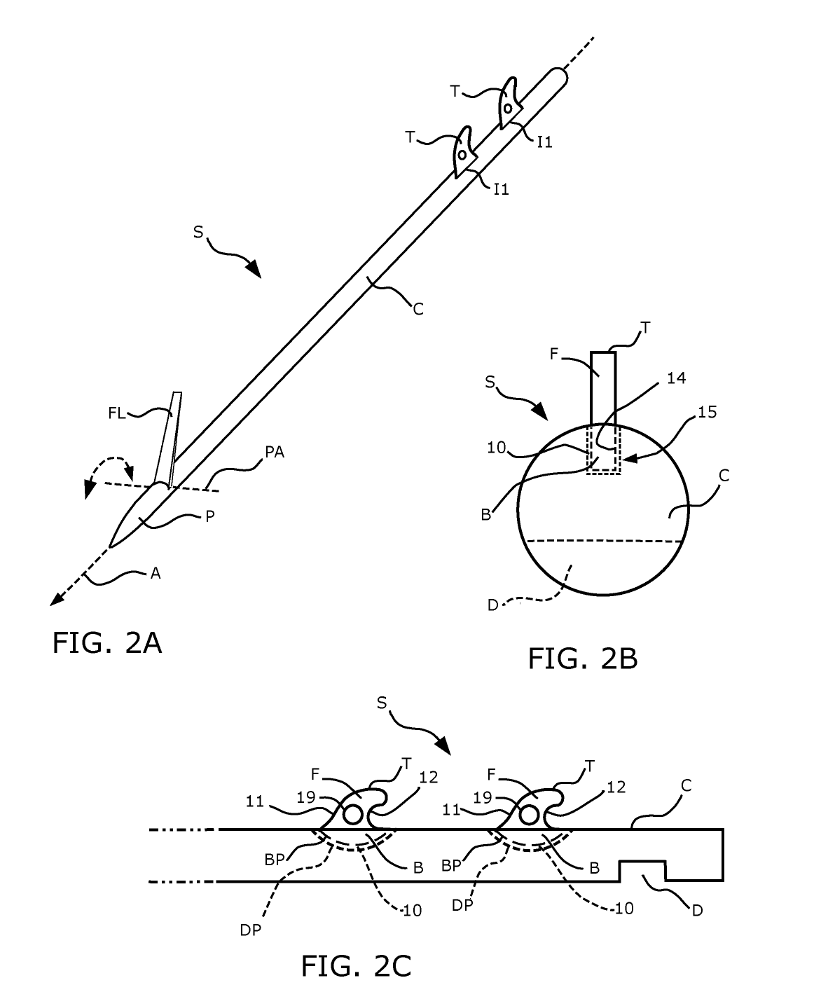

FIGS. 2A-2C show alternative views of a shaft assembly S according to embodiments of the present invention. FIG. 2A shows a perspective view of an example of the shaft assembly S. FIG. 2B shows a detailed end-view of an example of the shaft assembly S. FIG. 2C shows a detailed side-view of an example of a rear end of the shaft assembly S. The shaft assembly S includes a cylindrical body C that is typically formed from stainless steel, such as 17-4 or any other grade of metal that is suitable for underwater use. The cylindrical body C typically has a length between 30 inches and 75 inches and a diameter of approximately ⅜″, although the length and/or the diameter of the cylindrical body C may vary from these example dimensions and are typically designated based on the type of spear gun (not shown) with which the shaft assembly S may be mated.

The cylindrical body C of the shaft assembly S shown in FIG. 2A includes a pointed penetrating tip P on a front end. The penetrating tip P may be formed as an integral part of cylindrical body C, as in the example shown. In this example, the penetrating tip P includes a “flopper” FL that is pivotally mounted on the cylindrical body C of the shaft assembly S. In the firing state, the shaft assembly S is propelled by the elastic bands (not shown) of the spear gun in the direction of a main axis A of the cylindrical body C. This forward motion of the shaft assembly S results in a resistive force through the water that typically causes the flopper FL to pivot on its pin axis PA, so that the flopper FL is swept back in a streamlined position along the cylindrical body C. Once the flopper engages or pierces a target, such as a fish or other prey, the flopper FL is typically free to pivot along the pin axis PA into an open position to serve as a barb that may help to prevent the target from separating from the shaft assembly S.

Alternatively, the penetrating tip P may include a machined or threaded portion (not shown) that is adapted to engage a “slip-tip”, screw-on tip, or other separately manufactured tip mechanism. With some types of tip mechanisms, such as slip-tip, the flopper FL may be redundant or unnecessary, and may be omitted from the shaft assembly S. Various tip mechanisms and configurations are known in the art of spear guns and are commercially available from various suppliers. The shaft assembly S according to embodiments of the present invention may include any machined or otherwise formed front end that is suitable to accommodate any of a variety of configurations of penetrating tips P and manufactured tip mechanisms. For clarity, one or more of the penetrating tip P, the flopper FL and a detent D may be omitted from the various Figures in order to emphasize various details of the shaft assembly S according to the embodiments of the present invention.

On a rear end of the cylindrical body C distal to the penetrating tip P, the cylindrical body C typically includes a “tang”, or detent D (shown in FIGS. 2B-2C) that engages a trigger mechanism (not shown) that is typically integrated with the stock of a spear gun. In the example shown in FIGS. 2B-2C, the detent D has a rectangular shape and is shown formed on a lower portion of the cylindrical body C, while two tabs T are shown positioned on an upper portion of the cylindrical body C. However, depending on the type of trigger mechanism used, the detent D may have an alternative shape to accommodate a corresponding trigger mechanism. The detent D may alternatively be positioned on the top portion of the cylindrical body C to the rear of the tabs T, or in any other position that is designated to accommodate the corresponding trigger mechanism.

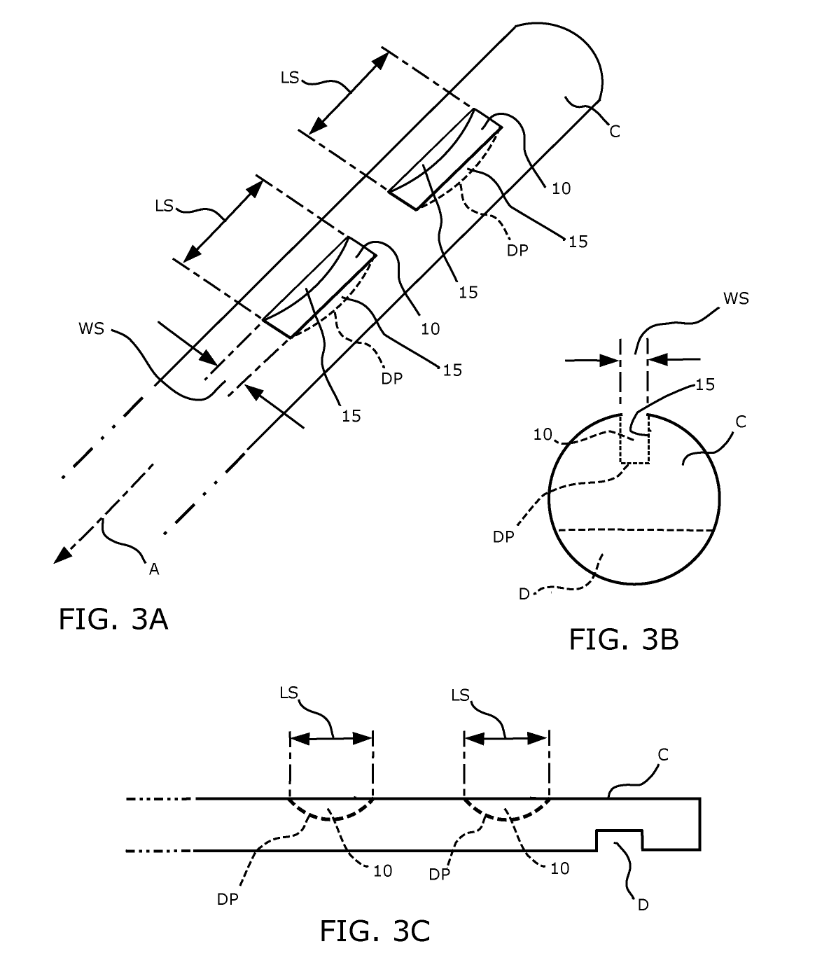

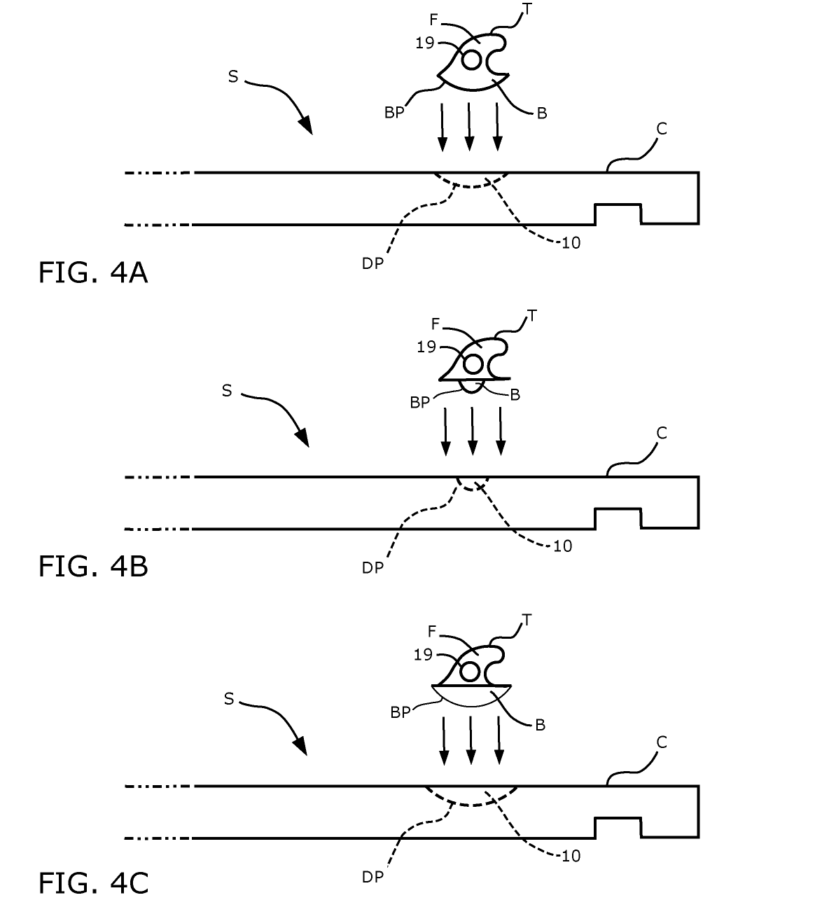

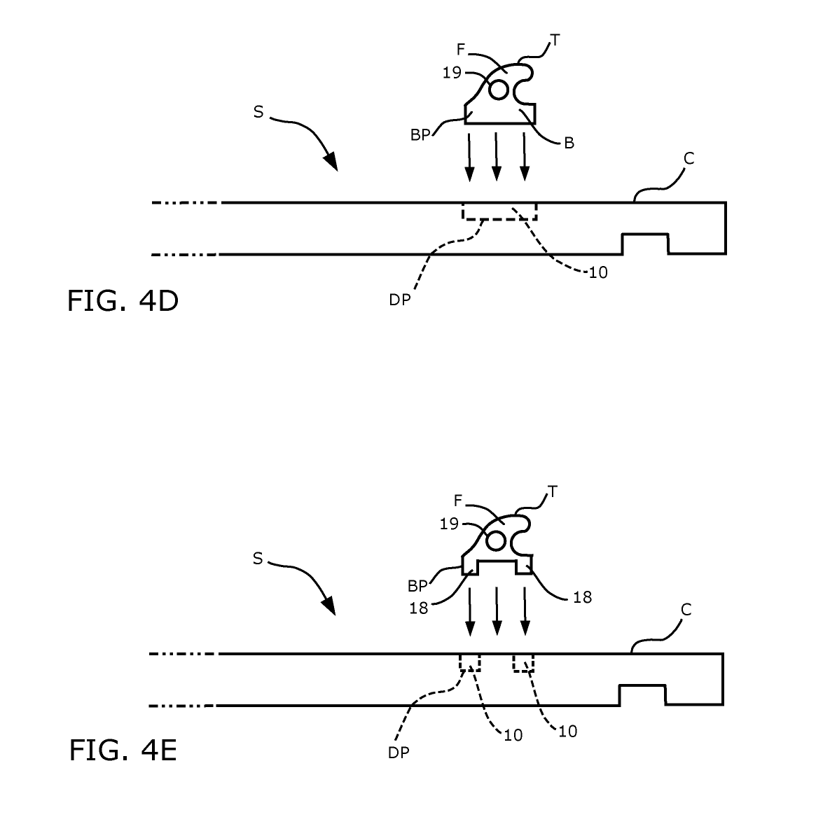

The cylindrical body C of the shaft assembly S includes one or more recessed slots 10, each having a length LS aligned with a main axis A of the cylindrical body C, having a width WS and having a depth profile DP as shown in the example embodiment of the present invention in FIGS. 3A-3C. In the example shown, the cylindrical body C includes two recessed slots 10, and in each recessed slot 10, the depth profile DP forms a radial arc with a designated radius and is typically formed using an edge-cut milling process. In the alternative example embodiments of the present invention shown in FIGS. 4D-4E, the recessed slot 10 has a depth profile DP that is rectangular.

The shaft assembly S also includes the one or more tabs T that are seated within the recessed slots 10 of the cylindrical body C of the shaft assembly S as shown in FIGS. 2A-2C. The tabs T are typically formed from the same type of metal as the cylindrical body C. Alternatively, the tabs T are formed from a material that is sufficiently compatible to the material of the cylindrical body C to enable mechanical coupling between the tab T and cylindrical body C.

Each tab T includes a fin portion F and a base B. The fin portion F of each tab T has a profile that resembles a shark fin and has a convex leading edge 11 and a concaved trailing edge 12. The convex leading edge 11 of the fin portion F provides for efficient flow through water when the shaft assembly S is propelled from a spear gun. The convex leading edge 11 also enables smooth disengagement of the elastic bands and reduces entanglement of the elastic bands with the tabs T as the shaft assembly S is propelled from the stock of the spear gun during the firing state. The convex leading edge 11 may also facilitate loading a spear gun, by enabling an operator of a spear gun to easily maneuver the wishbone of the elastic bands past this convex leading edge 11 when stretching an elastic band over the tab T to place the spear gun in the loaded state. The concaved trailing edge 12 of the fin portion of the tab T is adapted to receive and engage the wishbone of the elastic band when the spear gun is in the loaded state.

The tab T, including the fin portion F and base B, is typically formed by a milling process. Alternatively, the tab T may be formed by stamping, water-jet cutting, chemical etching, laser cutting, by a combination of these processes, or by any manufacturing process suitable to result in the tab T having the fin portion F and the base B. The convex leading edge 11 of the fin portion F is optionally “softened”, by chamfering, beveling, grinding, polishing, tumbling or other suitable process to avoid sharp edges, to further facilitate “loading” of the spear gun, whereby the one or more elastic bands are stretched beyond the convex leading edge 11 to engage the concaved trailing edge 12. The concaved trailing edge 12 may optionally be similarly “softened” by chamfering, beveling, grinding, polishing, tumbling or other suitable process to avoid any sharp interfaces of the concaved trailing edge 12 that may otherwise damage the elastic band or wishbone. In one example, the edges of the fin are “softened”, or made less sharp, by machining a micro-bevel on the edges of the convex leading edge 11 and the convex trailing edge 12, while the edges of the base B remain well-defined and controlled. The optional softening of either one or both of the convex leading edge 11 and the concaved trailing edge 12 may be omitted to simplify manufacturing of the tab T.

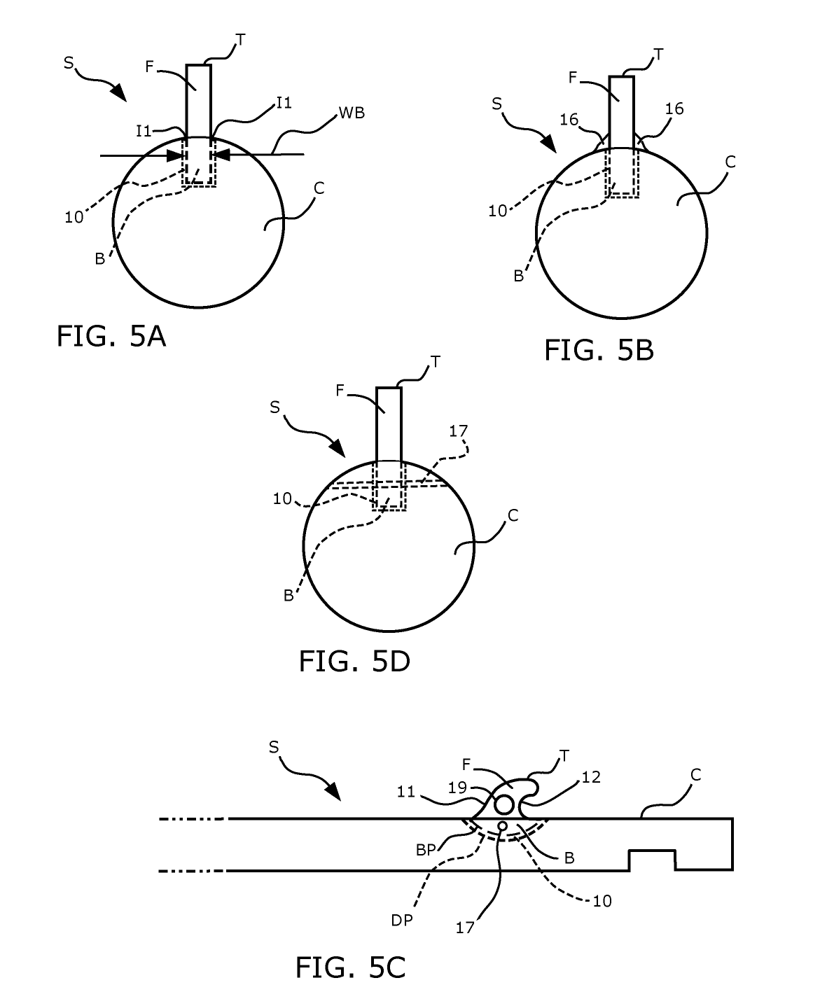

The base B of the tab T shown in the example embodiments of FIGS. 4A-4C has a curved base profile BP with a matching designated radius and is adapted to engage the recessed slot 10 which has the corresponding depth profile DP. The base B has a width WB (shown in FIG. 5A) that is dimensioned to provide a “slip fit”, or other secure fit, within the length LS and the width WS of the recessed slot 10 (shown in FIGS. 2A-3B).

When positioned into the recessed slot 10, the base B of the tab T is seated within the cylindrical body C of the shaft assembly S, while the fin portion F is exposed and protrudes from the cylindrical body C in a radial orientation from the main axis A as shown in FIGS. 2B-2C. With the base B inserted into the recessed slot 10, a mechanical contact results between the base profile BP of the base B and the depth profile DP of the recessed slot 10, the sidewalls 14 of the base B and the sidewalls 15 that define the width WS of the recessed slot 10, or both. The seating of the base B within the recessed slot 10 provides one form of mechanical coupling between the tab T and cylindrical body C of the shaft assembly S.

In one example, the mechanical coupling between the tab T and cylindrical body C is enhanced by a fusion weld. Fusion welding, alternatively referred to as “fuse welding”, or “seam welding”, provides a localized fusion of the metals at the interface I1 between the cylindrical body C and the junction between the fin portion F and the base B, as shown in FIG. 5A. The parameters of the fusion welding process are typically adjusted or empirically determined to provide sufficient strength to the mechanical coupling between the tab T and the cylindrical body C, while limiting overheating that may warp or otherwise adversely affect the cylindrical body C of the shaft assembly S.

Alternatively, the tab T is welded to the cylindrical body C using a deeper penetration weld that forms a larger fillet 16 between the fin portion F and the cylindrical body C as shown in the example shaft assembly S of FIG. 5B. In another example, the base B is secured within the recessed slot 10 using one or more dowels 17 that penetrate the cylindrical body C and the base B as shown in the example shaft assembly S of FIGS. 5C-5D. However, once the base B of the tab T is seated within the recessed slot 10, the mechanical coupling between the tab T and cylindrical body C may be enhanced using any attachment process, fastening process or configuration that is suitable to securely fasten the tab T to the cylindrical body C with sufficient strength to withstand the forces imposed on the tab T when the spear gun is in the loaded state and firing states.

FIGS. 4D-4E show alternative examples of shapes for the base B of the tab T and corresponding depth profiles DP of the recessed slot 10 according to embodiments of the present invention. In the example of FIG. 4D, the base B is shown having a base profile BP that is rectangular. In this example, the recessed slot 10 has a depth profile DP that is also rectangular to match the base profile BP. In the example of FIG. 4E, the base B is shown having a base profile BP that includes a pair of insertion blocks 18. In this example, the recessed slot 10 includes a depth profile DP that has a pair of rectangular recesses to match and receive the pair of insertion blocks 18. Typically, the base profile BP has a shape that matches the depth profile DP of the recessed slot 10. In alternative examples, the base profile BP and the depth profile DP may have shapes that are dissimilar, but that also sufficiently match to still enable the base B of the tab T to be seated within the recessed slot 10.

The tab T typically includes a hole or “eye” 19 through the fin portion F to accommodate a shooting line or other tether (not shown) for the shaft assembly S, so that the shaft assembly S may be retrieved once the shaft assembly S is fired from a spear gun. When the shaft assembly S includes a single tab T recessed within and fastened to the cylindrical body C, that single tab T typically includes an eye 19. When the shaft assembly S includes multiple tabs T, the fin portion F of at least one of the tabs T includes the eye 19. In one example, the front-most tab T of the multiple tabs T includes the eye 19. For manufacturing uniformity, all of the multiple tabs T of the shaft assembly S may include an eye 19.

When the shaft assembly S includes multiple tabs T, the tabs T are typically arranged in a tandem configuration, so that the tabs T are collinear and aligned with the main axis A of the cylindrical body C of the shaft assembly S.

While the embodiments of the present invention have been illustrated in detail, it should be apparent that modifications and adaptations to these embodiments may occur to one skilled in the art without departing from the scope of the present invention as set forth in the following claims.

1. A shaft assembly for a band-powered spear gun, comprising:
a cylindrical body, including at least one recessed slot, each of the at least one recessed slots having a length aligned with a main axis of the cylindrical body, having a width and having a depth profile; and
at least one tab, each of the at least one tab having a base and a fin portion, the base adapted to engage a corresponding one of the at least one recessed slot within the length and the width of the recessed slot, enabling the base to be seated within the recessed slot of the cylindrical body.

2. The shaft assembly of claim 1 wherein the base has a base profile to match the depth profile of the recessed slot.

3. The shaft assembly of claim 2 wherein the depth profile of each of the at least one recessed slot included in the cylindrical body has a radial arc.

4. The shaft assembly of claim 2 wherein the fin portion of each of the at least one tab protrudes from the cylindrical body.

5. The shaft assembly of claim 2 wherein at least one of a bottom of the base and a sidewall of the base contact at least one of the depth profile of the recessed slot and a sidewall of the recessed slot, respectively.

6. The shaft assembly of claim 1 wherein the at least one tab is fusion welded at an interface between the cylindrical body and a junction between the base and fin portion of the at least one tab.

7. The shaft assembly of claim 1 further including a weld fillet at an interface between the cylindrical body and a junction between the base and fin portion of the at least one tab.

8. The shaft assembly of claim 2 wherein when the at least one recessed slot includes multiple recessed slots in a collinear tandem configuration.

9. A shaft assembly, comprising:
a cylindrical body including multiple recessed slots arranged in a tandem configuration aligned with a main axis of the cylindrical body, each slot having a length, a width and a depth profile; and
multiple tabs, each tab having a base and a fin portion, the base adapted to engage a corresponding recessed slot within the length and the width of the recessed slot, and having a base profile to match the depth profile of the recessed slot.

10. The shaft assembly of claim 9 wherein the base of each of the multiple tabs is seated within a corresponding one of the multiple recessed slots of the cylindrical body.

11. The shaft assembly of claim 9 wherein the depth profile has a radial arc.

12. The shaft assembly of claim 9 wherein the depth profile is rectangular.

13. The shaft assembly of claim 9 wherein the depth profile includes a pair of rectangular recesses.

14. The shaft assembly of claim 10 wherein each of the bases is mechanically coupled within the corresponding recessed slot with a fusion weld.

15. The shaft assembly of claim 10 further comprising a weld fillet formed between an interface between the cylindrical body and a junction between the base and fin portion of each of the multiple tabs.

16. A shaft assembly, comprising:
a cylindrical body having a main axis, the cylindrical body including at least one recessed slot having a length aligned with the main axis and having a width and having a depth profile; and
at least one tab, each of the at least one tab having a base and a fin portion, the base adapted to engage a corresponding one of the at least one recessed slot within the length and the width of the at least one recessed slot, and having a bottom profile to match the depth profile of the at least one recessed slot, wherein in an engaged position, the base of each of the at least one tab is seated within the corresponding one of the at least one recessed slot of the cylindrical body and the fin portion of the at least one tab protrudes from the cylindrical body.

17. The shaft assembly of claim 16 wherein the at least one tab is secured within the at least one recessed slot with a dowel that penetrates the cylindrical body and the base of the at least one tab.

18. The shaft assembly of claim 16 wherein the at least one tab is secured within the at least one recessed slot with a fusion weld.

19. The shaft assembly of claim 16 further including a weld fillet formed at an interface between the cylindrical body and a junction between the base and fin portion of the at least one tab and the cylindrical body.

20. The shaft assembly of claim 16 wherein the depth profile has a radial arc.
